(19) United States
(12) Patent Application Publication
(10) Pub. No.: US 2012/0002138 A1
(43) Pub. Date: Jan. 5, 2012

(54) Pattern forming ink composition, light guide plate, light emitting unit and liquid crystal display element having the light emitting unit

(75) Inventors: Chih-Hung Lin, Taichung (TW); Chia Hui Yu, Tainan (TW)

(73) Assignee: CHI-MEI CORPORATION

(21) Appl. No.: 13/067,763

(22) Filed: Jun. 24, 2011

(30) Foreign Application Priority Data
Jul. 5, 2010 (TW) 099122086

(51) Int. Cl. G02F 1/13357; F21V 7/22; G02B 6/26; C09D 11/10

(52) U.S. Cl. 349/65; 522/168; 362/606; 385/39

(57) ABSTRACT

The present invention relates to a pattern forming ink composition, and more particularly, to a pattern forming ink composition having high yellowing resistance, wherein the pattern forming ink composition including an acrylate-based resin having a ring structure (A), a compound having at least one ethylenically unsaturated double bond (B) and a photoinitiator (C). The pattern forming ink is printed as a reflection pattern on a light guide plate to scatter and reflect the light incident to the reflection pattern towards a light emitting surface of the light guide plate.

### BACKGROUND OF THE INVENTION

(a) Field of the Invention

The present invention relates to a pattern forming ink composition, and more particularly, to a pattern forming ink composition, a light guide plate whereon the pattern is formed by using the ink composition, a light emitting unit having the light guide plate, and a liquid crystal display element having the light emitting unit.

(b) Description of the Prior Art

A display apparatus extensively used in equipment such as personal computers, televisions, mobile phones, and so on, has a liquid crystal display element. Since the liquid crystal panel of such liquid crystal display element is not a light-emitting device, a surface light source, called backlight module, is necessarily placed for illumination to enable the display. In recent years, a backlight having a light source placed on the edge of the light guide plate called side light type backlight module which transmit the light emitted from the light source to form a surface light source by total reflection is usually used for slim liquid crystal display applications, such as light and small notebook computers, and so on, instead of using a direct type backlight module which disposes a reflecting plate below the light source.

In the aforementioned side light type backlight module, a printing pattern distributed on the bottom surface of the light guide plate may be used to break up the total reflection of the light, causing irregular scattering and reflection inside the light guide plate, thereby guiding the light to pass through the light guide plate and emit from the light emitting surface. Japanese Patent Publication No. 2008-095103 discloses the use of a pattern forming ink composition comprising a polymer resin including an acrylic-based resin, a cross-linking agent including hexamethylene diisocyanate, and a filler. However, applying such ink to form a pattern causes the problem of yellowing issue extremely easily.

### SUMMARY OF THE INVENTION

The primary objective of the present invention lies in providing a pattern forming ink composition having high yellowing resistance, wherein the pattern forming ink composition comprising an acrylate-based resin having a ring structure (A), a compound having at least one ethylenically unsaturated double bond (B) and a photoinitiator (C).

Another objective of the present invention lies in providing a light guide plate including a light receiving surface, a light emitting surface, and a bottom surface opposite to the emitting surface and including a reflection pattern to scatter and reflect the incident light, wherein the reflection pattern is formed by using the pattern forming ink composition described.

Further objective of the present invention lies in providing a light emitting unit including a light generator comprising a light source and the light guide plate as described above, wherein the light guide plate connecting to the light generator emitting light into the light guide plate and the bottom surface of the light guide plate including a reflection pattern to scatter and reflect the aforementioned light.

Further objective of the present invention lies in providing a liquid crystal display element including the light emitting unit as described above and a liquid crystal panel arranged above the emitting surface of the light guide plate of the light emitting unit and using the emitted light to display an image.

To enable a further understanding of said objectives and the technological methods of the invention herein, a brief description of the drawings is provided below followed by a detailed description of the preferred embodiments and Examples.

### BRIEF DESCRIPTION OF THE DRAWINGS

FIG. 1 shows an exploded side cross-sectional view illustrating the light emitting unit of the present invention; and

FIG. 2 shows an exploded perspective view illustrating the liquid crystal display element of the present invention.

### BRIEF DESCRIPTION OF THE TABLES

Table 1 shows the formulations of Synthesis Example of the acrylate-based resin having a ring structure (A) according to the present invention; and

Table 2 shows the formulations and evaluation results of Examples and Comparative Examples of the pattern forming ink composition according to the present invention.

### DETAILED DESCRIPTION OF THE PREFERRED EMBODIMENTS AND EXAMPLES

The following gives a detailed description of each component of the present invention. In the drawings, the size or scale may, however, be exaggerated for clarity and should not be construed as limited to the present invention.

In the present invention, (meth)acrylic acid is used to represent acrylic acid and/or methacrylic acid. Similarly, (meth)acrylate represents acrylate and/or methacrylate; (meth)acryloyl represents acryloyl and/or methacryloyl; (meth) acryloyloxy represents acryloyloxy and/or methacryloyloxy.

### Pattern Forming Ink Composition

### Acrylate-Based Resin Having a Ring Structure (A)

The acrylate-based resin having a ring structure (A) of the present invention comprises an acrylate-based monomer having a ring structure (a-1) and other copolymerizable monomer having at least one ethylenically unsaturated double bond (a-2).

Examples of the acrylate-based monomer having a ring structure (a-1) include: four-membered ring compounds such as 3-(meth)acryloyloxymethyl oxetane, 3-(meth)acryloyloxymethyl-3-ethyl oxetane, 3-(meth)acryloyloxymethyl-2-methyl oxetane, 3-(meth)acryloyloxymethyl-2-trifluoromethyl oxetane, 3-(meth)acryloyloxymethyl-2-pentafluoroethyl oxetane, 3-(meth)acryloyloxymethyl-2-phenyl oxetane, 3-(meth)acryloyloxymethyl-2,2-difluoro oxetane, 3-(meth)acryloyloxymethyl-2,2,4-trifluoro oxetane, 3-(meth)acryloyloxymethyl-2,2,4,4-tetrafluoro oxetane, 3-(meth)acryloyloxyethyl oxetane, 3-(meth)acryloyloxyethyl-3-ethyl oxetane, 2-ethyl-3-(meth)acryloyloxyethyl oxetane, 3-(meth)acryloyloxyethyl-2-trifluoromethyl oxetane, 3-(meth)acryloyloxyethyl-2-pentafluoroethyl oxetane, 3-(meth)acryloyloxyethyl-2-phenyl oxetane, 2,2-difluoro-3-(meth)acryloyloxyethyl oxetane, 3-(meth)acryloyloxyethyl-2,2,4-trifluoro oxetane, 3-(meth)acryloyloxyethyl-2,2,4,4-tetrafluoro oxetane, 2-(meth)acryloyloxymethyl oxetane, 2-methyl-2-(meth)acryloyloxymethyl oxetane, 3-methyl-2-(meth)acryloyloxymethyl oxetane, 4-methyl-2-(meth)acryloyloxymethyl oxetane, 2-(meth)acryloyloxymethyl-2-trifluoromethyl oxetane, 2-(meth)acryloyloxymethyl-3-trifluoromethyl oxetane, 2-(meth)acryloyloxymethyl-4-trifluoromethyl oxetane, 2-(meth)acryloyloxymethyl-2-pentafluoroethyl oxetane, 2-(meth)acryloyloxymethyl-3-pentafluoroethyl oxetane, 2-(meth)acryloyloxymethyl-4-pentafluoroethyl oxetane, 2-(meth)acryloyloxymethyl-2-phenyl oxetane, 2-(meth)acryloyloxymethyl-3-phenyl oxetane, 2-(meth)acryloyloxymethyl-4-phenyl oxetane, 2,3-difluoro-2-(meth)acryloyloxymethyl oxetane, 2,4-difluoro-2-(meth)acryloyloxymethyl oxetane, 3,3-difluoro-2-(meth)acryloyloxymethyl oxetane, 3,4-difluoro-2-(meth)acryloyloxymethyl oxetane, 4,4-difluoro-2-(meth)acryloyloxymethyl oxetane, 2-(meth)acryloyloxymethyl-3,3,4-trifluoro oxetane, 2-(meth)acryloyloxymethyl-3,4,4-trifluoro oxetane, 2-(meth)acryloyloxymethyl-3,3,4,4-tetrafluoro oxetane, 2-(meth)acryloyloxyethyl oxetane, 2-(meth)acryloyloxyethyl-2-methyl oxetane, 2-(meth)acryloyloxyethyl-4-methyl oxetane, 2-(meth)acryloyloxyethyl-2-trifluoromethyl oxetane, 2-(meth)acryloyloxyethyl-3-trifluoromethyl oxetane, 2-(meth)acryloyloxyethyl-4-trifluoromethyl oxetane, 2-(meth)acryloyloxyethyl-2-pentafluoroethyl oxetane, 2-(meth)acryloyloxyethyl-3-pentafluoroethyl oxetane, 2-(meth)acryloyloxyethyl-4-pentafluoroethyl oxetane, 2-(meth)acryloyloxyethyl-2-phenyl oxetane, 2-(meth)acryloyloxyethyl-3-phenyl oxetane, 2-(meth)acryloyloxyethyl-4-phenyl oxetane, 2,3-difluoro-2-(meth)acryloyloxyethyl oxetane, 2,4-difluoro-2-(meth)acryloyloxyethyl oxetane, 3,3-difluoro-2-(meth)acryloyloxyethyl oxetane, 3,4-difluoro-2-(meth)acryloyloxyethyl oxetane, 4,4-difluoro-2-(meth)acryloyloxyethyl oxetane, 2-(meth)acryloyloxyethyl-3,3,4-trifluoro oxetane, 2-(meth)acryloyloxyethyl-3,4,4-trifluoro oxetane, 2-(meth)acryloyloxyethyl-3,3,4,4-tetrafluoro oxetane, cyclobutyl (meth)acrylate, and the like; five-membered ring compounds such as tetrahydrofurfuryl (meth)acrylate, caprolactone modified tetrahydrofurfuryl (meth)acrylate, cyclopentyl (meth)acrylate, cyclopenta-2,4-dienyl (meth)acrylate, (2-methyl-2-isobutyl-1,3-dioxolan-4-yl)methyl (meth)acrylate, (2-ethyl-2-methyl-1,3-dioxolan-4-yl)methyl (meth)acrylate, (1,4-dioxaspiro[4,5]dec-2-yl)methyl (meth)acrylate, (2,2-dimethyl-1,3-dioxolan-4-yl)methyl (meth)acrylate, and the like; six-membered ring compounds such as 3-vinylcyclohexyl (meth)acrylate, 3,3,5-trimethylcyclohexyl (meth)acrylate, 1-methylcyclohexyl (meth)acrylate, 4-tert-butylcyclohexyl (meth)acrylate, 3-vinyl-2-butylcyclohexyl (meth)acrylate, cyclohexyl (meth)acrylate, (meth)acryloyl morpholine, 1,4-cyclohexanedimethanol mono(meth)acrylate, tetrahydropyran (meth)acrylate, 2-methyltetrahydropyran (meth)acrylate, and the like; seven-membered ring compounds such as cycloheptyl (meth)acrylate, and the like; eight-membered ring compounds such as cyclooctyl (meth)acrylate, and the like. Among these, cyclic ether acrylate-based monomer having a ring structure which is four-membered or more than four-membered may be preferred, and cyclic ether acrylate-based monomer having a ring structure which is five-membered or more than five-membered may be more preferred.

The aforementioned acrylate-based monomer having a ring structure (a-1) may be used alone or as a mixture of two or more.

Examples of the other copolymerizable monomer having at least one ethylenically unsaturated double bond (a-2) include: carboxyl group-containing unsaturated monomers such as (meth)acrylic acid, crotonic acid, α-chloracrylic acid, ethyl acrylic acid, cinnamic acid, maleic acid, maleic anhydride, fumaric acid, itaconic acid, itaconic anhydride, citraconic acid, citraconic anhydride, and the like; aromatic vinyl compounds such as styrene, α-methylstyrene, vinyltoluene, chlorostyrene, methoxystyrene, and the like; unsaturated carboxylates such as methyl (meth)acrylate, ethyl (meth)acrylate, propyl (meth)acrylate, butyl (meth)acrylate, 2-hydroxyethyl (meth)acrylate, lauryl acrylate, tetradecyl acrylate, hexadecyl acrylate, stearyl acrylate, octadecyl acrylate, eicosyl acrylate, docosyl acrylate, and the like; unsaturated amino alkyl carboxylates such as aminoethyl (meth)acrylate, aminopropyl (meth)acrylate, and the like; vinyl carboxylates such as vinyl acetate, vinyl propionate, vinyl butyrate, vinyl benzoic ester, and the like; unsaturated ethers such as vinyl methyl ether, vinyl ethyl ether, allyl glycidyl ether, methallyl glycidyl ether, and the like; vinyl cyanides such as acrylonitrile, methacrylonitrile, α-chlorolacrylonitrile, vinylidene cyanide, and the like; unsaturated amides or unsaturated imides such as acrylamide, methacrylamide, α-chloroacrylamide, N-hydroxyethyl acrylamide, N-hydroxyethyl methacrylamide, maleic amide, and the like; aliphatic conjugate dienes such as 1,3-butadiene, isoprene, chloropropylene, and the like; macromonomers such as polystyrene, polymethylacrylate, polymethylmethacrylate, polybutylacrylate, polybutylmethacrylate, polysiloxane, and the like, which have a monoacryloyl group or a monomethacryloyl group at the end of the polymer molecule chain. Among these, (meth)acrylate, styrene, methyl (meth)acrylate, 2-hydroxyethyl (meth)acrylate and polymethyl methacrylate macromonomer may be preferred.

The aforementioned other copolymerizable monomer having at least one ethylenically unsaturated double bond (a-2) may be used alone or as a mixture of two or more.

The acrylate-based resin having a ring structure (A) of the present invention can be obtained by using various types of well-known mixer or disperser to uniformly mix the acrylate-based monomer having a ring structure (a-1) and other copolymerizable monomer having at least one ethylenically unsaturated double bond (a-2), and adding a polymerization initiator with 0.01% to 3% by weight at room temperature based on the above acrylate-based monomer (a-1) and the above monomer having at least one ethylenically unsaturated double bond (a-2), moreover, an organic solvent can be used as needed.

Examples of the polymerization initiator include: peroxides such as benzoyl peroxide, and the like; azo compounds such as 2,2′-azobis(isobutyronitrile) (AIBN for short), 2,2′-azobis(methylbutyronitrile) (AMBN for short), and the like.

Examples of the organic solvent include: ethylene glycol monopropyl ether, diethylene glycol dimethyl ether, tetrahydrofuran, ethylene glycol monomethyl ether, ethylene glycol monoethyl ether, methyl cellosolve acetate, diethylene glycol monomethyl ether, diethylene glycol monoethyl ether, diethylene glycol monobutyl ether, propylene glycol monomethyl ether acetate, propylene glycol monoethyl ether acetate, propylene glycol monopropyl ether acetate, ethyl 3-ethoxy propionate, methyl ethyl ketone, acetone, and the like. Among these, diethylene glycol dimethyl ether, propylene glycol monomethyl ether acetate, ethyl 3-ethoxy propionate may be preferred. The aforementioned organic solvents may be used alone or as a mixture of two or more.

Based on 100 parts by weight of the acrylate-based monomer having a ring structure (a-1) and the other copolymerizable monomer having at least one ethylenically unsaturated double bond (a-2) while mixing, the amount of (a-1) is generally 10 to 45 parts by weight, preferably 15 to 40 parts by weight, and more preferably 20 to 35 parts by weight.

When the amount of the acrylate-based monomer having a ring structure (a-1) is in the range of 10 to 45 parts by weight, an acrylate-based resin having a ring structure (A) polymerizated with excellent uniformity can be obtained, and a pattern forming ink composition with no yellowing issue while forming a pattern can be also obtained.

### Compound Having at Least One Ethylenically Unsaturated Double Bond (B)

The compound having at least one ethylenically unsaturated double bond (B) of the present invention can be a compound having one ethylenically unsaturated double bond, or a compound having two or more ethylenically unsaturated double bond.

Examples of the aforementioned compound having one ethylenically unsaturated double bond include: acrylamide, (meth)acryloylmorpholine, 7-amino-3,7-dimethyloctyl (meth)acrylate, isobutoxymethyl (meth)acrylamide, isobornyloxyethyl (meth)acrylate, isobornyl (meth)acrylate, 2-ethylhexyl (meth)acrylate, ethyl diethylene glycol (meth)acrylate, tert-octyl (meth)acrylamide, diacetone (meth)acrylamide, dimethylamino (meth)acrylate, dodecyl (meth)acrylate, dicyclopentenyloxyethyl (meth)acrylate, dicyclopentenyl (meth)acrylate, N,N-dimethyl (meth)acrylamide, tetrachlorophenyl (meth)acrylate, 2-tetrachlorophenoxyethyl (meth)acrylate, tetrahydrofurfuryl (meth)acrylate, tetrabromophenyl (meth)acrylate, 2-tetrabromophenoxyethyl (meth)acrylate, 2-trichlorophenoxyethyl (meth)acrylate, tribromophenyl (meth)acrylate, 2-tribromophenoxyethyl (meth)acrylate, 2-hydroxylethyl (meth)acrylate, 2-hydroxylpropyl (meth)acrylate, vinylcaprolactam, N-vinylpyrrolidone, phenoxyethyl (meth)acrylate, pentachlorophenyl (meth)acrylate, pentabromophenyl (meth)acrylate, bornyl (meth)acrylate, polyethylene glycol mono(meth)acrylate, polypropylene glycol mono(meth)acrylate, and the like.

Examples of the aforementioned compound having two or more ethylenically unsaturated double bond include: ethylene glycol di(meth)acrylate, dicyclopentenyl di(meth)acrylate, triethylene glycol di(meth)acrylate, tetraethylene glycol di(meth)acrylate, tri(2-hydroxyethyl) isocyanate di(meth)acrylate, tris(2-hydroxyethyl) isocyanate tri(meth)acrylate, caprolactone modified tris(2-hydroxyethyl) isocyanate tri(meth)acrylate, trimethyloylpropane tri(meth)acrylate, ethyleneoxide (hereinafter abbreviated as EO) modified trimethyloylpropane tri(meth)acrylate, propyleneoxide (hereinafter abbreviated as PO) modified trimethyloylpropane tri(meth)acrylate, triethylene glycol di(meth)acrylate, neopentyl glycol di(meth)acrylate, 1,4-butanediol di(meth)acrylate, 1,6-hexadiol di(meth)acrylate, pentaerythritol tri(meth)acrylate, pentaerythritol tetra(meth)acrylate, polyester di(meth)acrylate, polyethylene glycol di(meth)acrylate, dipentaerythritol hexa(meth)acrylate, dipentaerythritol penta(meth)acrylate, dipentaerythritol tetra(meth)acrylate, caprolactone modified dipentaerythritol hexa(meth)acrylate, caprolactone modified dipentaerythritol penta(meth)acrylate, ditrimethyloylpropane tetra(meth)acrylate, EO modified bisphenol A di(meth)acrylate, PO modified bisphenol A di(meth)acrylate, EO modified hydrogenated bisphenol A di(meth)acrylate, PO modified hydrogenated bisphenol A di(meth)acrylate, PO modified glycerol tri(meth)acrylate, EO modified bisphenol F di(meth)acrylate, phenol novolac polyglycidyl ether (meth)acrylate, and the like. Among these, trimethyloylpropane triacrylate, EO modified trimethyloylpropane triacrylate, PO modified trimethyloylpropane triacrylate, pentaerythritol triacrylate, pentaerythritol tetraacrylate, dipentaerythritol hexaacrylate, dipentaerythritol pentaacrylate, dipentaerythritol tetraacrylate, caprolactone modified dipentaerythritol hexaacrylate, ditrimethyloylpropane tetraacrylate may be preferred.

The compound having at least one ethylenically unsaturated double bond (B) may be used alone or as a mixture of two or more.

The amount of the compound having at least one ethylenically unsaturated double bond (B) is generally 5 to 200 parts by weight, preferably 10 to 150 parts by weight, and more preferably 20 to 120 parts by weight, based on 100 parts by weight of the acrylate-based resin having a ring structure (A).

### Photoinitiator (C)

The photoinitiator (C) of the present invention can be selected from a group containing an oxime compound (C-1), an acetophenone compound (C-2) and other photoinitiator (C-3).

Examples of the oxime compound (C-1) include: Ethanone, 1-[9-ethyl-6-(2-methylbezoyl) 9H-carbozole-3-yl]-1-(O-acetyl oxime) (OXE02, manufactured by Ciba Specialty Chemicals), Ethanone, 1-[9-ethyl-6-(2-chloro-4-benzylsulfonyl benzoyl) 9H-carbozole-3-yl]-1-(O-acetyl oxime) (manufactured by Asahi Denka, 1-(4-phenyl-thiophenyl)-butane-1,2-dion 2-oxime-O benzoate, 1-(4-phenyl-thiophenyl)-octane-1,2-dion 2-oxime-O-benzoate (OXE01, manufactured by Ciba Specialty Chemicals), 1-(4-phenyl-thiophenyl)-octane-1-on oxime-O-acetate, 1-(4-phenyl-thiophenyl)-butane-1-on oxime-O-acetate, and the like.

Examples of the acetophenone compound (C-2) include: p-dimethylamino acetophenone, α,α′-dimethoxyazoxyacetophenone, 2,2′-dimethyl-2-acetophenone, p-methoxy acetophenone, 2-methyl-1-(4-methylthiophenyl)-2-morpholino-1-propanone, 2-benzyl-2-N,N-dimethylamino-1-(4-morpholinophenyl)-1-butanone, and the like.

Examples of the other photoinitiator (C-3) include: biimidazole compounds such as 2,2′-bis(o-chlorophenyl)-4,4′,5,5′-tetraphenyl biimidazole, 2,2′-bis(o-fluorophenyl)-4,4′,5,5′-tetraphenyl biimidazole, 2,2′-bi s(o-methylphenyl)-4,4′,5,5′-tetraphenyl biimidazole, 2,2′-bis(o-methoxyphenyl)-4,4′,5,5′-tetraphenyl biimidazole, 2,2′-bis(p-methoxyphenyl)-4,4′,5,5′-tetraphenyl biimidazole, 2,2′-bis(2,2′,4,4′-tetramethoxyphenyl)-4,4′,5,5′-tetraphenyl biimidazole, 2,2′-bis(2,2′-dichlorophenyl)-4,4′,5,5′-tetraphenyl biimidazole, and the like; benzophenone compounds such as thioxantone, 2,4-diethylthioxantone, thioxantone-4-sulphone, benzophenone, 4,4′-bis(dimethylamino)benzophenone, 4,4′-bis(diethylamino) benzophenone, and the like; α-diketone compounds such as benzil, acetyl, and the like; acyloin compounds such as benzoin, and the like; acyloin ethers such as benzoin methyl ether, benzoin ethyl ether, benzoin isopropyl ether, and the like; acylphosphine oxide compounds such as 2,4,6-trimethylbenzoyl diphenylphosphine oxide, bis-(2,6-dimethoxybenzoyl)-2,4,4-trimethyl benzylphosphine oxide, and the like; quinone compounds such as anthraquinone, 1,4-naphthoquinone, and the like; halide compounds such as phenacyl chloride, tribromomethyl phenylsulfone, tris(trichloromethyl)-s-triazine), and the like; peroxide compounds such as di-tertbutyl peroxide, and the like.

The aforementioned photoinitiator (C) can be used alone or as a mixture of two or more. The amount of the photoinitiator (C) is generally 2 to 120 parts by weight, preferably 5 to 70 parts by weight, and more preferably 10 to 60 parts by weight, based on 100 parts by weight of the compound having at least one ethylenically unsaturated double bond (B).

### Additive (D)

An additive (D) such as a silane coupling agent, a filler, a defoamer, or the like, may be further added to the pattern forming ink composition of the present invention if necessary.

Examples of the silane coupling agent include: vinyltrichlorosilane, vinyltriethoxysilane, vinyltris(β-methoxy-ethoxy)silane, β-(3,4-epoxycyclohexyl)ethyltrimethoxy silane, γ-glycidoxypropyltrimethoxy silane, γ-glycidoxypropylmethyldiethoxy silane, γ-(meth)acryloyloxypropyltrimethoxy silane, N-(β-aminoethyl)-γ-aminopropyltrimethoxy silane, N-(β-aminoethyl)-γ-aminopropyl trimethyldimethoxy silane, N-phenyl-γ-aminopropyltrimethoxy silane, γ-chloropropyl trimethoxy silane, γ-mercaptopropyltrimethoxy silane, γ-aminopropyltrimethoxy silane, bis-1,2-(trimethoxysilyl)ethane and SH6062, SZ6030 (trade names, manufactured by Toray Dow Corning Silicone), KBE-903, KBE-603, KBE-403 (trade names, manufactured by Shin-Etsu Chemicals), and the like.

The amount of the silane coupling agent is generally 0 to 30 parts by weight, preferably 3 to 25 parts by weight, and more preferably 5 to 20 parts by weight, based on 100 parts by weight of the acrylate-based resin having a ring structure (A).

The filler may be used in the present invention includes organic fillers and/or inorganic fillers. Examples of organic fillers include: epoxy resin, melamine resin, urea resin, acrylic resin, novolac resin, polyimide resin, polyamide resin, polyester resin, teflon resin, and the like. Examples of inorganic fillers include: aluminum oxide, aluminum hydroxide, silicon dioxide, magnesium oxide, magnesium hydroxide, ferric oxide, titanium dioxide, zinc oxide, tin oxide, silicon nitride, aluminum nitride, talc, mica, asbestos powder, quartz powder, kaolin, bentonite, diatomite, zeolite, gypsum, glass beads, glass fiber, barium sulfate, magnesium sulfate, calcium carbonate, magnesium carbonate, calcium silicate, aluminum silicate, zirconium silicate, potassium titanate, fullerene, and the like. The filler may be used alone or as a mixture of two or more.

The average diameter of the filler used in the present invention, which is not particular limited, is generally less than 10 μm, preferably less than 5 μm, and more preferably less than 3 μm. The amount of the filler is generally 2 to 70 parts by weight, preferably 5 to 60 parts by weight, and more preferably 10 to 50 parts by weight, based on 100 parts by weight of the acrylate-based resin having a ring structure (A).

Examples of the defoamer of the present invention include: Surfynol MD-20, Surfynol MD-30, EnviroGem AD01, EnviroGem AE01, EnviroGem AE02, Surfynol DF 110D, Surfynol 104E, Surfynol 420, Surfynol DF 37, Surfynol DF58, Surfynol DF 66, Surfynol DF 70, Surfynol DF 210, and the like (trade names, manufactured by Air Products). The amount of the defoamer is generally 1 to 10 parts by weight, preferably 2 to 9 parts by weight, and more preferably 3 to 8 parts by weight, based on 100 parts by weight of the acrylate-based resin having a ring structure (A).

For the preparation of the pattern forming ink composition according to the present invention may be formed by using various types of well-known mixer or disperser to uniformly mix the above-mentioned components (A) to (C) and the additives (D) such as a silane coupling agent, a filler, a defoamer, or the like.

### Light Guide Plate

A reflection pattern can be obtained by first printing the pattern forming ink composition on a light guide plate with printing methods such as inkjet, screen printing, imprinting, or the like, and drying thereafter.

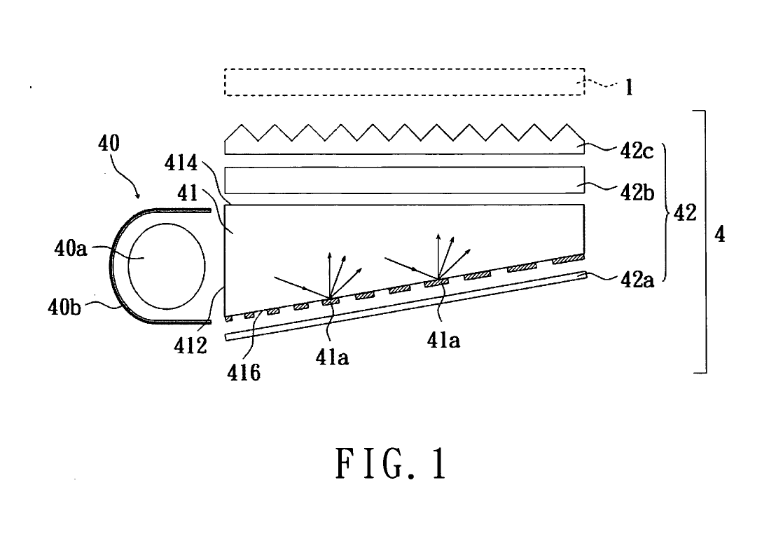

FIG. 1 shows an exploded cross-sectional view illustrating the light emitting unit of the present invention. Referring to FIG. 1, the light guide plate (41) of the present invention includes a light receiving surface (412), a light emitting surface (414), and a bottom surface (416) opposite the light emitting surface (414). Wherein, the bottom surface (416) adjoins the light receiving surface (412) at one side of the light guide plate (41) with an oblique angle. Therefore, the light guide plate (41) may become thinner farther from the light receiving surface (412), so that the light is more uniformly emitted from the light emitting surface (414).

A reflection pattern (41a) described above, which is not limited on arrangement or dimension, is formed on the bottom surface (416) of the light guide plate (41). The reflection pattern (41a) causes scattering and reflection of the light incident onto the light guide plate (41) from the light receiving surface (412), and therefore the light is diffused in various directions uniformly. When printing the reflection pattern (41a), various shapes such as circular, rectangular and hexagonal shapes may be chosen. Moreover, the degree to which reflected light is scattered and the brightness of the reflection pattern (41a) may vary according to components of the pattern forming ink.

### Light Emitting Unit

Referring again to FIG. 1, the light emitting unit (4) of the present invention includes a light generator (40) and a light guide plate (41) as described above. Wherein, the light guide plate (41) is connected to the light generator (40) at one side, and the light receiving surface (412) faces the light generator (40) to receive the light emitted from the light generator (40) into the light guide plate (41). The light guide plate (41) guides the light supplied from the light generator towards the liquid crystal panel (1). The light generator (40) includes a light source (40a) and a lamp reflector (40b). The light source (40a) may be a light emitting diode having a point light source or a lamp having a line light source. The lamp reflector (40b) surrounds the light source (40a) except for an opened portion at one side approaching the light guide plate (41), thereby enabling the light generated from the light source (40a) to pass through the opened portion directly or by reflection from the lamp reflector (40b), then towards the light guide plate (41).

The light emitting unit (4) may further include an optical member (42), and the optical member (42) includes optical elements including a reflector she'et (42a), a diffuser sheet (42b), and a prism sheet (42c). The reflector sheet (42a) is adjacent to the bottom surface (416) of the light guide plate (41), and the light emitted from the bottom surface (416) is reflected back to the light guide plate (41) by the reflector sheet (42a). The diffuser sheet (42b) is adjacent to the light emitting surface (414) of the light guide plate (41) and diffuses the light emitted from the light emitting surface (414) of the light guide plate (41) so that the light is more uniformly diffused. The prism sheet (42c) is adjacent to the diffuser sheet (42b) and increases the brightness of forward direction towards the liquid crystal panel (1) by collecting the light.

### Liquid Crystal Display Element

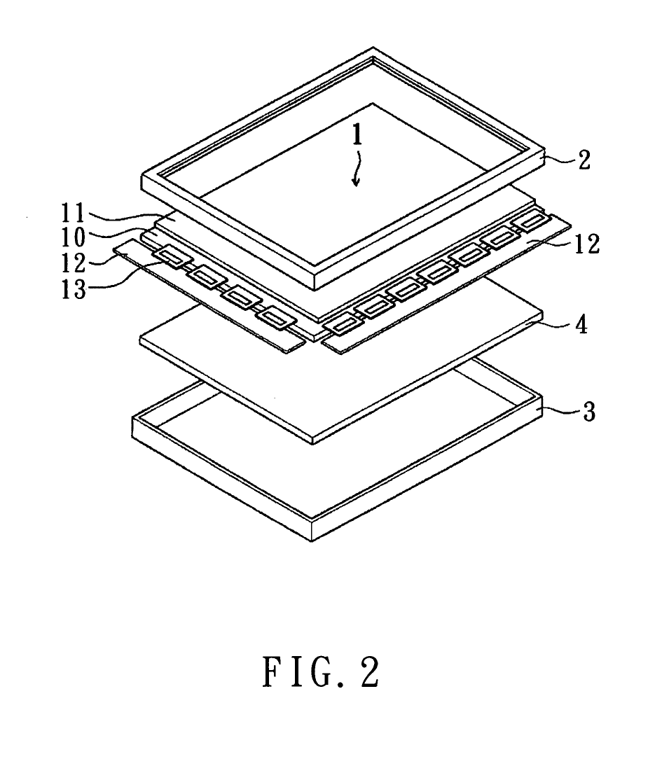

FIG. 2 shows an exploded perspective view illustrating the liquid crystal display element of the present invention. Referring to FIG. 2, the liquid crystal display element includes a liquid crystal panel (1) and a light emitting unit (4) as described above. Wherein, the liquid crystal panel (1) displays an image, and includes a thin-film transistor (TFT) substrate (10) (hereinafter referred to as a TFT substrate), a color filter (CF) substrate (11), and a liquid crystal layer containing liquid crystal (not shown).

A printed circuit board (12) containing a driving chip is connected to the TFT substrate (10) through Tape Carrier Packages (13). Various signals for displaying an image are transmitted to the TFT substrate (10) from the printed circuit board (12) and the driving chip (not shown).

The liquid crystal display element further includes a top chassis (2) and a bottom chassis (3). The bottom chassis (3) has an opened storage space in the upper surface, and the peripheral portion of the bottom chassis (3) supports the liquid crystal panel (1). In addition, the peripheral portion of the bottom chassis (3) is connected to the top chassis (2) which covers and fixes the peripheral portion of the liquid crystal panel (1) to prevent the printed circuit board (12) from being exposed to the exterior. An image display area of the liquid crystal panel (1) is exposed through the opening formed in the middle of the top cassis (2). The storage space of the bottom cassis (3) receives the aforementioned light emitting unit (4) which generates light and enables the light to pass through the liquid crystal panel (1), and the image is displayed thus.

It is to be understood that both the FIG. 1 and FIG. 2 are explanatory and this invention should not be construed as limited to them. Hence, the light emitting unit of the present invention may be also applied to other types of display equipment; the liquid crystal display element may also use other types of optical element such as polarizer.

Hereinafter, the present invention will be further illustrated more specifically by the following examples, although the scope of the present invention is by no way limited by these examples.

### DETAILED DESCRIPTION OF THE PREFERRED EXAMPLES AND COMPARATIVE EXAMPLES

### Preparation of Pattern Forming Ink Composition

### Synthesis Example 1

A mixture of 30 parts by weight of tetrahydrofuran acrylate, 25 parts by weight of methyl methacrylate, 44 parts by weight of n-butyl acrylate and 1 part by weight of azobis(methylbutyronitrile) was uniformly stirred by using a planetary mixer (ARB-310; manufactured by THINKY), and thermal polymerization was performed at a temperature of 80° C. for 24 hours, thereby obtaining an acrylic-based resin having a ring structure (A-1). The formulations were shown in Table 1.

### Synthesis Examples 2 to 5

The acrylate-based resins having a ring structure (A-2) to (A-5) were prepared by repeating the procedure of Synthesis Example 1, except that the kind and dosage of the raw materials were changed. The formulations were shown in Table 1.

### Comparative Synthesis Example 1

A mixture of 25 parts by weight of methyl methacrylate, 44 parts by weight of n-butyl acrylate, 30 parts by weight of 2-hydroxyethyl methylacrylate and 1 part by weight of azobis(methylbutyronitrile) was uniformly stirred by using a planetary mixer, and thermal polymerization was performed at a temperature of 80° C. for 24 hours, thereby obtaining an acrylic resin (PA-1).

### Comparative Synthesis Example 2

A mixture of 25 parts by weight of methyl methacrylate, 44 parts by weight of n-butyl acrylate, 30 parts by weight of glycidyl methacrylate and 1 part by weight of azobis(methylbutyronitrile) was uniformly stirred by using a planetary mixer, and thermal polymerization was performed at a temperature of 80° C. for 24 hours, thereby obtaining an acrylic resin (PA-2).

### Comparative Synthesis Example 3

A mixture of 25 parts by weight of methyl methacrylate, 44 parts by weight of n-butyl acrylate and 1 part by weight of azobis(methylbutyronitrile) was uniformly stirred by using a planetary stirring device, and thermal polymerization was performed at a temperature of 80° C. for 24 hours, thereby obtaining an acrylic resin (PA-3).

### Example 1

A mixture of 100 parts by weight of the acrylic-based resin having a ring structure (A-1) obtained in the above Synthesis Example 1, 80 parts by weight of 1,6-hexanediol diacrylate (B-1) and 8 parts by weight of the photoinitiator (C-1) (1-hydroxycyclohexylphenyl ketone, IRGACURE 184, manufactured by Ciba Specialty Chemicals) was uniformly stirred by using a planetary mixer. Thereafter, the mixture was kneaded for 3 hours by using a three-roll mill (FC-90 mm; manufactured by Farn Chang Co., Ltd.), thereby obtaining a pattern forming ink composition. The pattern forming ink composition was evaluated with the Evaluation Method described afterwards, and the results were shown in Table 2.

### Examples 2 to 5

The procedure of Example 1 is repeated, except that the kind and dosage of the raw materials were changed. The formulation and evaluation results were shown in Table 2.

### Comparative Example 1

The procedure of Example 1 is repeated, except that the resin (A-1) was replaced with resin (PA-1). The pattern forming ink composition was evaluated with the Evaluation Method described afterwards, and the results were shown in Table 2.

### Comparative Example 2

The procedure of Example 1 is repeated, except that the resin (A-1) was replaced with resin (PA-2). The pattern forming ink composition was evaluated with the Evaluation Method described afterwards, and the results were shown in Table 2.

### Comparative Example 3

The procedure of Example 1 is repeated, except that the resin (A-1) was replaced with resin (PA-3), and extra 20 parts by weight of tetrahydrofuran acrylate was added into the compound having at least one ethylenically unsaturated double bond (B). The pattern forming ink composition was evaluated with the Evaluation Method described afterwards, and the results were shown in Table 2.

### Evaluation Method

### Yellowing Resistance

The pattern forming ink composition was coated on a 100 mm×100 mm glass substrate by using a wet film applicator (ZFR 2040; manufactured by ZEHNTNER) to form a coating film having a film thickness of 30 μm. After irradiation with UV (AG500-4N; manufactured by M&R Nano Technology) in 850 mJ/cm², reliability treatment in a high-temperature and high-humidity chamber was performed with conditions of temperature of 50° C. and relative humidity of 80% for 500 hours. Thereafter, a chromaticity change (ΔE) of the film was measured by using a colorimeter (MC-3100; manufactured by Otsuka Electronics) before and after the reliability treatment.
⊚: ΔE<0.5
◯: 0.5≦ΔE≦1
Δ: 1<ΔE≦3
X: ΔE>3

While the present invention is illustrated with the preferred examples aforementioned, scope of the invention is not thus limited and the variations and modifications made in the present invention by those skilled in the art should be in the scope of the appended claims and their equivalents.

TABLE 1

| | | | | Copolymerizable | | | |
|---|---|---|---|---|---|---|---|
| | | | | Monomer Having | | | |
| | | | | At Least One | | | |
| Syn- | Acrylate-Based | | | Ethylenically | | | Polymer- |
| thesis | Monomer Having a | | | Unsaturated | | | ization |
| Ex- | Ring Structure (a-1) | | | Double Bond (a-2) | | | Initiator |
| ample | THFA | MM-OXE | CHMA | MMA | n-BA | HEMA | AMBN |
| A-1 | 30 | | | 25 | 44 | | 1 |
| A-2 | 10 | | | | 55 | 34 | 1 |
| A-3 | 45 | | | 20 | 20 | 14 | 1 |
| A-4 | | 30 | | 25 | 44 | | 1 |
| A-5 | 5 | | 25 | 25 | 44 | | 1 |

THFA tetrahydrofurfuryl acrylate
MM-OXE 3-methacryloyloxy methyl oxetane
CHMA cyclohexyl methacrylate
MMA methyl methacrylate
n-BA n-butyl acrylate
HEMA 2-hydroxyethyl methacrylate
AMBN [2,2′-azobis(methylbutyronitrile)]

TABLE 2

| | | Example | | | | | Comparative Example | | |
|---|---|---|---|---|---|---|---|---|---|
| Component | | 1 | 2 | 3 | 4 | 5 | 1 | 2 | 3 |
| Acrylate-Based Resin | A-1 | 100 | | | | | | | |
| Having a Ring Structure (A) | A-2 | | 100 | | | | | | |
| (parts by weight) | A-3 | | | 100 | | | | | |
| | A-4 | | | | 100 | | | | |
| | A-5 | | | | | 100 | | | |
| Acrylate-Based Resin | PA-1 | | | | | | 100 | | |
| (parts by weight) | PA-2 | | | | | | | 100 | |
| | PA-3 | | | | | | | | 100 |
| Compound Having At Least One | B-1 | 80 | 80 | 80 | 150 | 60 | 80 | 80 | 80 |
| Ethylenically Unsaturated Double | B-2 | | | | | 60 | | | |
| Bond (B) | B-3 | | | | | | | | 20 |
| (parts by weight) | | | | | | | | | |
| Photoinitiator (C) | C-1 | 8 | 8 | 6 | 8 | 8 | 8 | 8 | 8 |
| (parts by weight) | C-2 | | | 2 | | | | | |
| Additive (D) | D-1 | | | | | 30 | | | |
| (parts by weight) | D-2 | | 5 | | | | | | |
| Evaluation Method | Yellowing | ⊚ | ⊚ | ⊚ | ⊚ | ◯ | X | X | X |

B-1: 1,6-hexanediol diacrylate
B-2: pentaerythritol tetraacrylate
B-3: tetrahydrofurfuryl acrylate
C-1: IRGACURE 184, manufactured by Ciba Specialty Chemicals (1-hydroxycyclohexylphenyl ketone)
C-2: OXE02, manufactured by Ciba Specialty Chemicals (Ethanone, 1-[9-ethyl-6-(2-methylbezoyl) 9H-carbozole-3-yl]-1-(O-acetyl oxime))
D-1: IPA-ST, silicon dioxide particle, manufactured by Nissan Chemicals (average diameter 12 nm)
D-2: KBM-403, glycidoxypropyltrimethoxy silane, manufactured by Shin-Etsu Chemicals

What is claimed is:

1. A pattern forming ink composition, comprising:
an acrylate-based resin having a ring structure (A);
a compound having at least one ethylenically unsaturated double bond (B); and
a photoinitiator (C).

2. The pattern forming ink composition according to claim 1, wherein the acrylate-based resin having a ring structure (A) is formed by copolymerizing acrylate-based monomer having a ring structure (a-1) and copolymerizable monomer having at least one ethylenically unsaturated double bond (a-2).

3. The pattern forming ink composition according to claim 2, wherein the acrylate-based monomer having a ring structure (a-1) has a ring which is four-membered, five-membered, six-membered, seven-membered, or eight-membered.

4. A light guide plate, including:
a light receiving surface;
a light emitting surface; and
a bottom surface opposite to the light emitting surface and including a reflection pattern to scatter and reflect the light inside the light guide plate passing through the light receiving surface;
wherein the reflection pattern formed by the ink composition comprising:
an acrylate-based resin having a ring structure (A);
a compound having at least one ethylenically unsaturated double bond (B); and
a photoinitiator (C).

5. The light guide plate according to claim 4, wherein the acrylate-based resin having a ring structure (A) is formed by copolymerizing acrylate-based monomer having a ring structure (a-1) and copolymerizable monomer having at least one ethylenically unsaturated double bond (a-2).

6. The light guide plate according to claim 5, wherein the acrylate-based monomer having a ring structure (a-1) has a ring which is four-membered, five-membered, six-membered, seven-membered, or eight-membered.

7. A light emitting unit, including:
a light generator comprising a light source; and
a light guide plate connecting to the light generator at one side to guide the light supplied by the light generator;
wherein the light guide plate including:
a light receiving surface;
a light emitting surface; and
a bottom surface opposite to the light emitting surface and including a reflection pattern to scatter and reflect the light inside the light guide plate passing through the light receiving surface;
wherein the reflection pattern formed by the ink composition comprising:
an acrylate-based resin having a ring structure (A);
a compound having at least one ethylenically unsaturated double bond (B); and
a photoinitiator (C).

8. The light emitting unit according to claim 7, wherein the acrylate-based resin having a ring structure (A) is formed by copolymerizing acrylate-based monomer having a ring structure (a-1) and copolymerizable monomer having at least one ethylenically unsaturated double bond (a-2).

9. The light emitting unit according to claim 8, wherein the acrylate-based monomer having a ring structure (a-1) has a ring which is four-membered, five-membered, six-membered, seven-membered, or eight-membered.

10. A liquid crystal display element, including:
a liquid crystal panel; and
a light emitting unit emitting the light to pass through the liquid crystal panel;
wherein the light emitting unit including:
a light generator comprising a light source; and
a light guide plate connecting to the light generator at one side to guide the light supplied by the light generator;
wherein the light guide plate including:
a light receiving surface;
a light emitting surface; and
a bottom surface opposite to the light emitting surface and including a reflection pattern to scatter and reflect the light inside the light guide plate passing through the light receiving surface;
wherein the reflection pattern formed by the ink composition comprising:
an acrylate-based resin having a ring structure (A);
a compound having at least one ethylenically unsaturated double bond (B); and
a photoinitiator (C).

11. The liquid crystal display element according to claim 10, wherein the acrylate-based resin having a ring structure (A) is formed by copolymerizing acrylate-based monomer having a ring structure (a-1) and copolymerizable monomer having at least one ethylenically unsaturated double bond (a-2).

12. The liquid crystal display element according to claim 11, wherein the acrylate-based monomer having a ring structure (a-1) has a ring which is four-membered, five-membered, six-membered, seven-membered, or eight-membered.
